(19) United States
(12) Patent Application Publication
(10) Pub. No.: US 2010/0123004 A1
(43) Pub. Date: May 20, 2010

(54) METHOD AND DEVICE FOR THE AUTOMATED ACCESS CONTROL OF AIR PASSENGERS IN AIRPORTS

(76) Inventors: Rolf Felkel, Fuerth (DE); Jens Grabeleu, Trebur (DE)

Correspondence Address: HAYES SOLOWAY P.C., 3450 E. SUNRISE DRIVE, SUITE 140, TUCSON, AZ, 85718, US

(21) Appl. No.: 12/445,447

(22) PCT Filed: Oct. 12, 2007
(86) PCT No.: PCT/EP2007/008888

§ 371 Date: Jun. 22, 2009

(30) Foreign Application Priority Data
Oct. 13, 2006 (DE) 10 2006 048 618.8

(51) Int. Cl. G06K 5/00

(52) U.S. Cl. 235/382; 235/375

(57) ABSTRACT

In the method for automated access control of air passengers in airports, the boarding pass carried by an air passenger is evaluated. The data recorded as a bar code on the boarding pass is read by means of a bar code reader at a pass-through. A central database is used to check whether a blocking note is stored for the respective boarding pass. If this is not the case, the locking device of the pass-through is opened. As soon as the air passenger has passed through the pass-through, a blocking note relating to the boarding pass is dispatched and stored in the database.

The present invention relates to a method and a facility for automated access control of air passengers in airports by means of the boarding passes carried by the air passengers.

During check-in for a flight, a boarding pass is handed over to the air passenger. In the travel process chain up to boarding, the boarding pass is checked several times by the staff provided therefor. This check of the boarding passes, which is in line with the usual practice, is staff-intensive and satisfies only minimum security criteria. In particular, such a purely visual check of the boarding passes is unable to prevent the use of counterfeits.

The present invention makes use of the circumstance that the airlines issue boarding passes that are provided with a bar code encoding. The respective boarding passes are referred to as “Bar Coded Boarding Pass” (BCBP). At least the following data is stored in coded form on such a BCBP:
flight number
flight date
check-in sequence number.

On the basis of this data each boarding pass is uniquely identified.

By nature, a boarding pass may be used only once. The invention defined in the enclosed claims therefore proposes that the check of the boarding passes be automated by means of special pass-throughs. Bar code readers (scanners) are arranged at the pass-throughs and the air passenger is requested to present his/her boarding pass to the bar code reader. The data read in from the boarding pass is then matched against the data stock of a central database that can be reached airport-wide. Upon successful data matching, the locking means of the pass-through is temporarily opened. Subsequently, the passage of the air passenger through the pass-through is registered. After the air passenger has passed through the pass-through, a blocking note is transmitted to the database and registered therein. Now if a counterfeit boarding pass is used and a blocking note has already been registered for the genuine boarding pass, the user of the counterfeit boarding pass is rejected in the automated boarding pass check.

The automated boarding pass check provided according to the invention may fulfill a number of further tasks. For one thing, the data read out in the boarding pass check may be processed further for statistics purposes. Provision is further made for use of the passing of the pass-through as a criterion for loading items of baggage. In fact, if an air passenger for whose boarding pass no blocking note has been registered does not pass through the pass-through in spite of successful data matching, it may be prevented in this way that his/her baggage is loaded and needs to be unloaded again later.

Provision is furthermore made for utilizing the automated boarding pass check to systematically hold air passengers without sufficient security screenings (APIS, Advanced Passenger Information System) back in front of the gate and guide them to special service staff. Where special security screenings are prescribed for a flight (e.g. to the USA), the airline may store an appropriate note in the bar code on the boarding pass. This note is recognized in the boarding pass check and the air passenger is then requested to proceed to a special service point.

Details of the invention are illustrated in the accompanying drawings, in which:

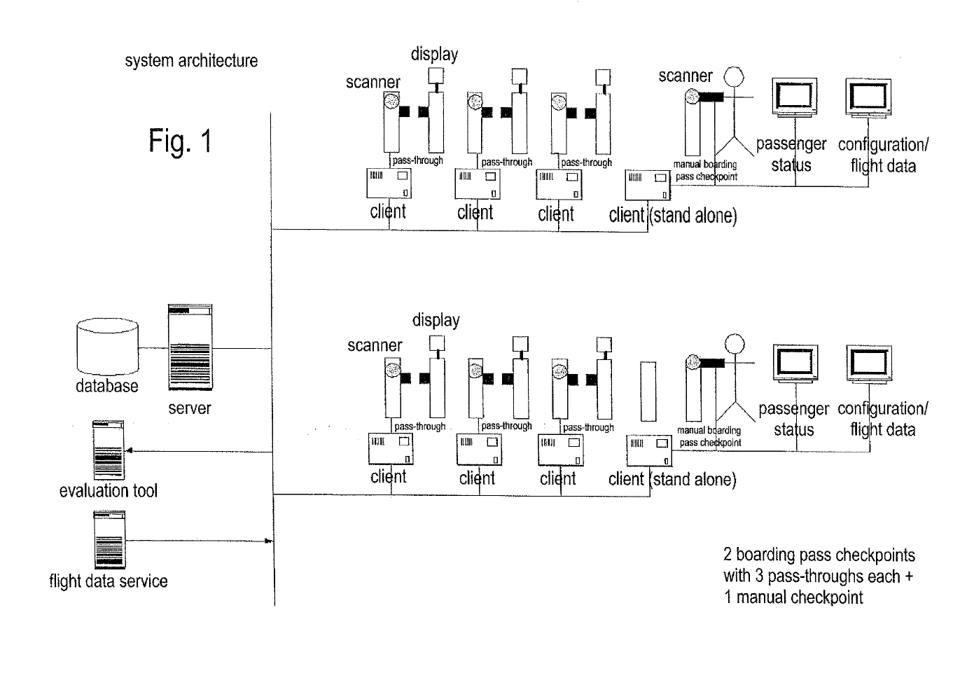

FIG. 1 shows an overview diagram of an airport facility for automated access control by means of boarding passes; and

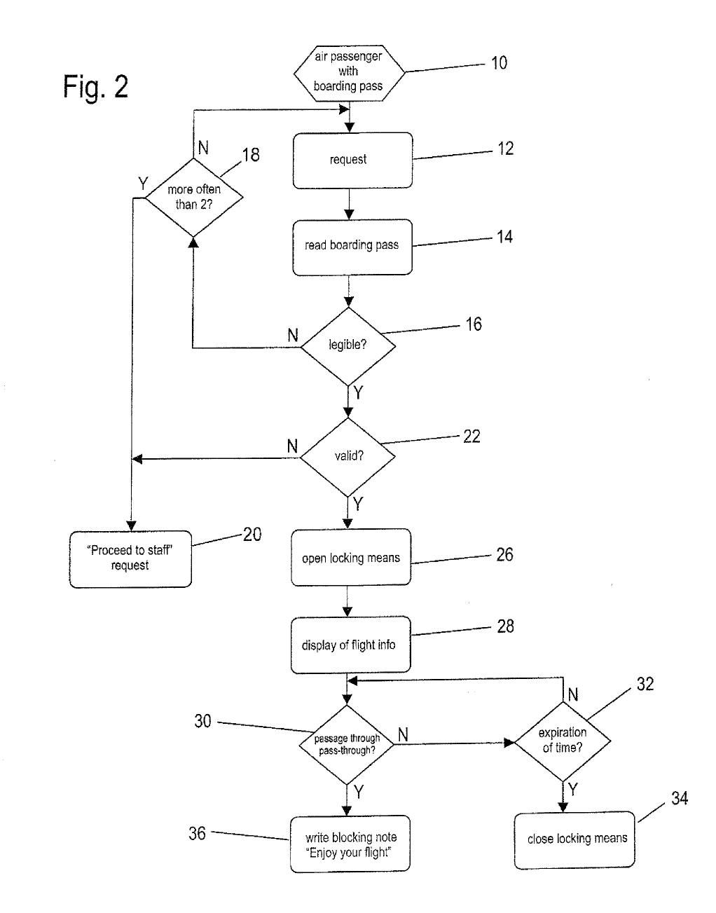

FIG. 2 shows a flow chart illustrating the sequence of the method for automated access control.

In the overview diagram illustrated in FIG. 1, it is presupposed that the premises of an airport are divided into generally accessible traffic areas and secured apron areas delimited therefrom. The air passengers are permitted to enter the secured apron area only through special pass-throughs where an automated boarding pass check is performed. FIG. 1 schematically shows two boarding pass checkpoints. Each boarding pass checkpoint includes a number of pass-throughs. In the example shown, three pass-throughs of this type are installed for fully automated operation. A further pass-through is installed in each of the two boarding pass checkpoints for assistance by special staff.

Each pass-through is equipped with a locking means, a control device (“client”) and a bar code reader. All control devices are connected to a central database via a network and the database can be reached airport-wide via the network. Since the automated boarding pass check must not generate any unreasonable waiting times at the pass-throughs, all components of the system are designed to have high power. The useful pieces of equipment of the pass-throughs include a display panel on which flight-relevant data is displayed to the air passengers. Each boarding pass checkpoint is further equipped with display consoles on which the data relevant to the check-in and handling process is displayed. The database is supported by a powerful server. In addition, data input stations are connected via the network which are used for inputting all relevant flight data into the database. For an evaluation of the data, special evaluation terminals can access the database via the network.

Reference is now made to FIG. 2.

In step 10 an air passenger arrives at a pass-through with his/her boarding pass. In step 12 the air passenger is requested to present his/her boarding pass to the bar code reader at the pass-through. In step 14 the boarding pass is read. In step 16 the boarding pass is checked for legibility. If it is not legible, the process is repeated. In step 18 a check is run as to whether more than two reading attempts have been made. If this applies, the air passenger is requested in step 20 to proceed to a particular service point. In step 22 it is checked whether the boarding pass is valid. If the boarding pass is invalid, the request is effected as in step 20. In step 26, the locking means of the pass-through is opened. In step 28 the data relevant to his/her flight is then displayed to the air passenger on the display panel of the pass-through. In step 30 it is checked whether the air passenger has passed through the pass-through. If this is not the case, a check is made in step 32 as to whether a waiting time of a few seconds has elapsed. If this is the case, it is assumed that the air passenger has not passed through the pass-through, and in step 34 the locking means of the pass-through is closed again. Otherwise, in step 36 a blocking note relating to the boarding pass is caused to be dispatched and stored in the database. At the same time, a message such as “Enjoy your flight” may be displayed on the display panel of the pass-through.

1: A method for automated access control of air passengers in airports using boarding passes carried by the air passengers during crossing from a traffic area to a secured apron area delimited therefrom;
in which:
pass-throughs are installed for the passengers between the traffic area and the secured apron area;
the pass-throughs are equipped with control devices;
the control devices of the pass-throughs are connected to a database of the airport;
the pass-throughs are equipped with controllable locks;
the locks are driven by the control devices;
the boarding passes are provided with a machine-readable code;
the pass-throughs are equipped with boarding pass code readers connected to the control devices;
comprising the following steps:
a) the air passenger presents his/her boarding pass to the reader at the pass-through;
b) the reader reads the code from the boarding pass;
c) the code data read out by the reader is transferred to the database;
d) the code data read out is matched against corresponding data stored in the database;
e) upon successful data matching, the lock is driven by the control device to release the passage for the air passenger;
f) after the air passenger has passed through the pass-through, a blocking note for the boarding pass of the air passenger is transmitted by the control device to the database and registered therein;
g) in the data matching in step d) it is checked whether a blocking note relating to the boarding pass concerned is registered in the database.

2: The method according to claim 1, wherein the data matching in step d) includes a check for fulfillment of security criteria.

3: The method according to claim 1, wherein in step f) a release information is issued to a baggage loading service.

4: An airport facility for carrying out the method according to claim 1, in which in the airport at least one traffic area is delimited from at least one secured apron area;
comprising:
pass-throughs installed for the passengers between the traffic area and the secured apron area;
control devices at the pass-throughs;
a database of the airport to which the control devices of the pass-throughs are connected;
a lock driven by the control devices, at the pass-throughs;
readers connected to the control devices for reading a machine-readable code on boarding passes;
the control devices of the pass-throughs being connected to a network that is installed in the airport and to which the database is also connected.

5: The facility according to claim 4, wherein the control devices of the pass-throughs have software applications installed thereon which have direct access to the database and, under normal operating conditions, ensure a data matching in approximately one second at the maximum.
